(19) United States
(12) Patent Application Publication
(10) Pub. No.: US 2010/0066377 A1
(43) Pub. Date: Mar. 18, 2010

(54) METHOD FOR DETERMINING THE BATTERY CAPACITY WITH THE AID OF CAPACITY-DEPENDENT PARAMETERS

(76) Inventors: Eberhard Schoch, Stuttgart-Feuerbach (DE); Burkhard Iske, Renningen-Malmsheim (DE); Michael Merkle, Stuttgart (DE)

Correspondence Address: KENYON & KENYON LLP, ONE BROADWAY, NEW YORK, NY, 10004, US

(21) Appl. No.: 12/305,121

(22) PCT Filed: Jun. 12, 2007
(86) PCT No.: PCT/EP2007/055771

§ 371 Date: Jul. 6, 2009

(30) Foreign Application Priority Data
Aug. 7, 2006 (DE) 10 2006 036 784.7

(51) Int. Cl. G01N 27/416

(52) U.S. Cl. 324/427

(57) ABSTRACT

A method for determining a battery variable, in particular capacity of battery, with the aid of a state variable and parameter estimator, which calculates from operating variables of battery state variables and parameters of a mathematical energy storage model. Capacity of battery may be determined very accurately when the battery is in operation if it is calculated as a function of at least one capacity-dependent parameter.

### FIELD OF THE INVENTION

The present invention relates to a method and device for determining a battery variable, in particular the capacity, of an energy store.

### BACKGROUND INFORMATION

In motor vehicle electrical systems, a battery and a generator usually supply electric power to electrical consumers. Generally, when the vehicle is in operation, an energy and consumer management is carried out in which individual consumers are automatically connected or disconnected, depending on requirements, in order to be able to react to supply bottlenecks or to execute specific functions, for example. Within the framework of this energy and consumer management, knowledge of the battery state is of fundamental importance.

To assess the battery state, mathematical battery models are used that describe the electrical and physical properties of the energy store. For example, the performance (SOF), the charge state (SOC), or the capacity or charge (Qe) able to be drawn may be assessed with the aid of a mathematical battery model.

The conventional battery models include a series of state variables and parameters that are constantly adapted to the current state of the battery when the vehicle electrical system is in operation. However, specific parameters of the battery model, such as the minimum open-circuit voltage at cutoff (U_{c0min}), may be determined accurately only when the charge state of the battery is very low, typically under approximately 50% of the charge able to be drawn. However, such deep discharges occur only extremely rarely in motor vehicle electrical systems and moreover are prevented by the energy management of the vehicle in order to avoid endangering the vehicle's ability to start and to keep battery aging through excessive cycling as minimal as possible.

### SUMMARY

It is an object of the present invention to create a method for determining a battery variable, in particular the capacity of the battery, with which method the required battery variable may be determined with a high degree of accuracy even outside of a deep discharge state, that is, for example, when the battery is in normal operation. Furthermore, it is to be possible to implement the method in the presence of the electrical excitations existing when the vehicle electrical system is in normal operation, and in particular it should not require any additional excitations, like those that appear when the engine is started, for example.

One example aspect of the present invention is to calculate the required battery variable as a function of at least one capacity-dependent parameter. In this context, the example embodiment of the present invention is based on the knowledge that in the course of battery operation, different battery parameters change relative to the new state, and thus the parameters and their change are an index for the battery state, in particular the capacity (lost capacity or remaining capacity) of the battery. The required battery variable may thus be determined very simply and accurately taking into consideration the at least one capacity-dependent parameter. Furthermore, apart from the excitations that normally exist when the vehicle electrical system is in operation, no additional excitations of the battery, such as actively triggered charging or discharging current impulses, are required to perform the calculation.

According to one preferred specific embodiment of the present invention, the required battery variable is calculated as a function of a minimum open-circuit voltage, which in turn is a function of at least one capacity-dependent parameter.

In particular, a parameter (e.g., R_{K025}) of the acid diffusion resistance (R_{K}) of the battery and/or a parameter (e.g. Vgr25) of the charge transfer resistance (R_{dp}) between electrolyte and an electrode of the battery may be used as capacity-dependent parameters. The parameters mentioned have in particular the advantage that they change relatively sharply when capacity loss increases, that is, they are relatively sensitive, and may be identified accurately when the vehicle electrical system is in operation, without additional active excitation.

The required battery variable is preferably calculated as a function of the deviation of one or more capacity-dependent parameters from a reference value, in particular an initial value in the new state of the battery. In the process, the degree of the deviation from the reference value is an index for the lost capacity of the battery.

According to one preferred specific embodiment of the present invention, the at least one capacity-dependent parameter is weighted with a predefined factor, which is preferably a function of the error variance with which the parameter was determined. Some types of state variable and parameter estimators output the error variance with which the state variable or the parameter was estimated in addition to the individual variables or parameters. This value may be used for the weighting of the capacity-dependent parameter.

The required battery variable, such as a capacity of the battery, for example, is preferably also calculated as a function of the maximum open-circuit voltage of the fully charged battery. The maximum open-circuit voltage is preferably learned using an adaptation algorithm at high charge states.

The calculation is preferably performed using an extended Kalman filter.

### BRIEF DESCRIPTION OF THE DRAWINGS

Below, the present invention is explained in greater detail by way of example, with reference to the figures.

FIG. 1 shows a device for calculating a battery state variable, in particular the charge able to be drawn from the battery.

FIG. 2 shows an equivalent circuit diagram for a lead accumulator.

### DETAILED DESCRIPTION OF EXAMPLE EMBODIMENTS

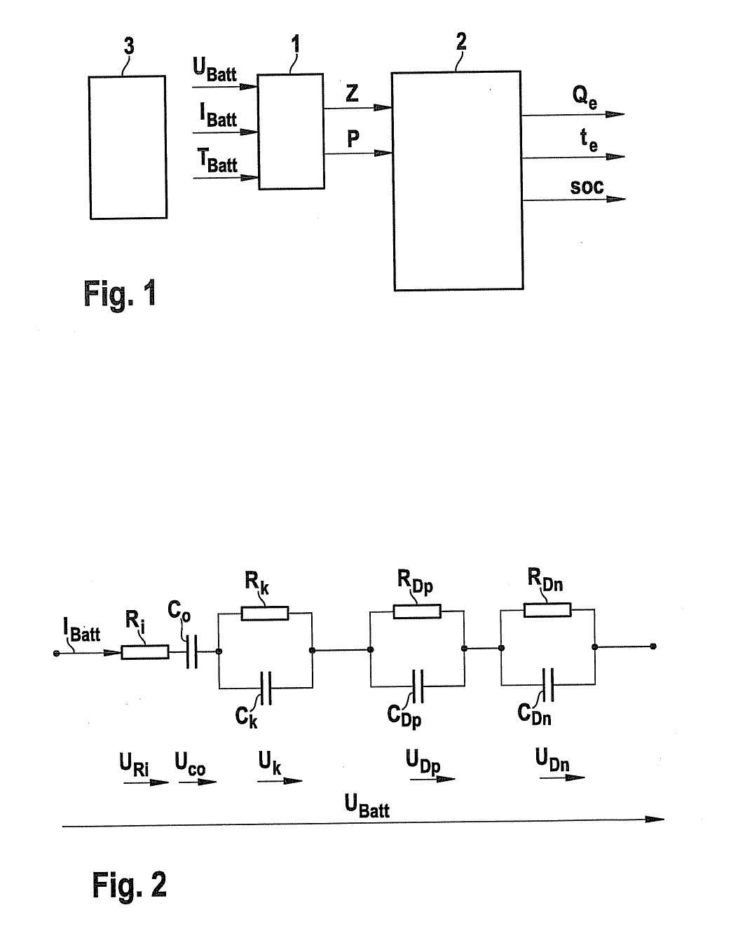

FIG. 1 shows a device for determining a battery variable, such as charge Qe able to be drawn from a battery (capacity), for example. The device generally includes a state variable and parameter estimator 1, and a charge predictor 2 (estimation device), in which a mathematical energy storage model is stored.

State variable and parameter estimator 1 uses the current operating variables of battery 4, to wit battery voltage U_{Batt}, battery current I_{Batt}, and battery temperature T_{Batt}, to calculate state variables Z and/or parameters P, on the basis of which charge predictor 2 calculates required battery state variable Qe, or other variables, such as charge state SOC or performance SOF of battery 4. In the following example, battery 4 is a lead accumulator.

In particular, internal voltages U, which are revealed by the equivalent circuit diagram of the battery shown in FIG. 2, are considered to be state variables Z. The parameters mentioned are in particular elements of the equivalent circuit diagram, such as, for example, resistances R and capacities C, or different values that appear in the functions of the mathematical battery model.

The calculation of battery capacity Qe ensues from the current state of the energy store. Therefore, the mathematical models stored in charge predictor 2 are first initialized to the current operating state of energy store 4. To this end, state variable and parameter estimator 1 supplies the corresponding initial values. A conventional Kalman filter may be used as a state variable and parameter estimator, for instance. While the battery is in operation, state variables Z and parameters P are constantly newly adapted to the current state and the functions of the battery model adapted in this manner.

FIG. 2 shows an equivalent circuit diagram of a lead accumulator 4. In this context, the individual variables are as follows:

Operating Variables:

I_{Batt} battery current

U_{Batt} terminal voltage of the battery

T_{Batt} acid temperature

State Variables:

U_{C0} open-circuit voltage

Uₖ concentration polarization

U_{DP} charge transfer polarization of the positive electrode

U_{Dn} charge transfer polarization of the negative electrode Parameters:

Rᵢ (U_{C0}, Uₖ, T_{Batt}, Rᵢ₀₂₅, U_{C0min}, U_{C0max}) Ohmic internal resistance, dependent on open-circuit voltage U_{C0}, concentration polarization Uₖ, acid temperature T_{Batt}, internal resistance Rᵢ₀₂₅, which is based on 25° C. and full charge, and minimum open-circuit voltage U_{C0min} at cutoff and maximum open-circuit voltage U_{C0max} at full charge,

C₀ acid capacity

Rₖ (U_{C0}, T_{Batt}, Rₖ₀₂₅, U_{C0max}) acid diffusion resistance, dependent on open-circuit voltage U_{C0}, charge transfer polarization of the positive electrode, acid temperature T_{Batt}, acid diffusion resistance R_{K025}, which is based on 25° C. and full charge, and maximum open-circuit voltage U_{C0max} at full charge,

Cₖ capacity of the acid diffusion,

R_{Dp} (U_{c0}, U_{Dp}, T_{Batt}, I_{Dp}, V_{gr25}, U_{C0max}) charge transfer resistance between positive electrode and electrolyte, dependent on open-circuit voltage U_{C0}, the charge transfer polarization of positive electrode U_{Dp}, acid temperature T_{Batt}, charge transfer current of positive electrode I_{Dp}, saturation voltage of charge transfer polarization V_{gr25}, which is based on 25° C., and maximum open-circuit voltage U_{C0max} at full charge,

C_{Dp} double-layer capacity between positive electrode and electrolyte,

R_{Dn} (U_{Dn} T_{Batt}, I_{Dn}) charge transfer resistance between negative electrode and electrolyte, dependent on the charge transfer polarization of negative electrode U_{Dn}, acid temperature T_{Batt}, and the charge transfer current of negative electrode I_{Dp},

C_{Dn} double-layer capacity between negative electrode and electrolyte.

The individual equivalent circuit diagram variables result from various physical effects of battery 3, which are known to one skilled in the art from the relevant literature.

For example, the following function may be used for acid diffusion resistance R_{K}:

R_{K}=f(U_{C0}, T_{Batt}, Rₖ₀₂₅, U_{comax})

In this context, Rₖ₀₂₅ is the diffusion resistance of the acid at 25° C. and with a fully charged battery. Rₖ₀₂₅ is a capacity-dependent parameter.

For charge transfer resistance R_{Dp} between electrolyte and the positive electrode of lead accumulator 3, the following function may be used, for example:

R_{Dp}=f(U_{c0}, U_{Dp}, T_{Batt}, I_{Dp}, V_{gr25}, U_{C0max})

In this context, V_{gr25} is the polarization voltage of the positive electrode at high discharge currents and 25° C. V_{gr25} is a capacity-dependent parameter.

Accordingly, charge predictor 2 includes other mathematical approaches for other state variables (e.g. U_{Dp}, U_{Dn}, U_{K}, etc.) and parameters (e.g. R_{Dn}, C₀, Rᵢ, etc.).

Conventionally, the following relationship is valid for capacity Qe of energy store 3:

Qe=C₀·(U_{c0max}−U_{c0min})

In this context, C₀ is the acid capacity of battery 3, U_{c0max} the open-circuit voltage when the battery is fully charged, and U_{c0min} the open-circuit voltage at cutoff.

In order to obtain a sufficiently accurate result for capacity Qe of battery 3, parameters C₀, U_{c0min} and U_{C0max} must be determined with sufficient accuracy. For parameters C₀ and U_{C0max}, this is readily possible when the battery is in normal operation (close to fully charged). However, parameter U_{c0min} may only be accurately calculated at low charge states <50%. Since these operating states occur only extremely rarely, the desired accuracy of the capacity calculation is achieved only rarely. It is thus proposed to calculate parameter U_{c0min} with the aid of parameters R_{K025} and vgr25, which are a function of the capacity of battery 3. The available capacity Qe of battery 3 may thereby be ascertained without additional excitations of the battery when the vehicle electrical system is in normal operation, the battery not having to be discharged to low charge states.

For example, the following relationship may be used for the open-circuit voltage of battery 3 at cutoff U_{c0min}:

U_{c0min}_corr=U_{c0min}+g1·ΔR_{K25}−g2·Δvgr25.

In this context, ΔR_{K25} and Δvgr25 are the changes to parameters R_{K25} and vgr25, respectively, relative to a corresponding reference value, in particular, the value of battery 3 in the new state. Factors g1 and g2 are weighting factors.

In this instance, changes ΔR_{K25} and Δvgr25 are weighted proportionally to the accuracy with which parameters R_{K25} and vgr25 were estimated from state variable and parameter estimator 1. To this end, Kalman filter 1 outputs corresponding error variances P, which influence weighting factors g1 and g2. For example, weighting factors g1 and g2 may be expressed in the following way:

g1˜(P₀(R_{K025})−P(R_{K025}))/P₀(R_{K025})

g2˜(P₀(vgr25)−P(vgr25))/P₀(vgr25)

In this context, P₀(R_{K025}) and P₀(vgr25) are initial error variances of the corresponding parameters, and P(R_{K025}) and P(vgr25) the current error variances estimated by Kalman filter 1 for parameters R_{K025} and vgr25.

Instead of deviation ΔR_{K25} or Δvgr25, the deviation of a parameter of double-layer capacity C_{Dp} between positive electrode and electrolyte could be used alternatively or additionally.

At low charge states, in particular <50%, parameter Rᵢ₀₂₅ of the internal resistance or its change may also influence the calculation of open-circuit voltage U_{c0min}, at cutoff.

1-11. (canceled)

12. A method for determining a battery variable of an energy store, comprising:
calculating from operating variables of the energy store, state variables and parameters of a mathematical energy storage model, wherein the battery variable of the energy store is calculated as a function of at least one capacity-dependent parameter.

13. The method as recited in claim 12, wherein the battery variable is a capacity of the energy store.

14. The method as recited in claim 12, wherein the battery variable is calculated as a function of a minimum open-circuit voltage, and the minimum open-circuit voltage is calculated as a function of the at least one capacity-dependent parameter.

15. The method as recited in claim 12, wherein the battery variable is calculated as a function of a capacity-dependent parameter of an acid diffusion resistance of the energy store.

16. The method as recited in claim 12, wherein the battery variable is calculated as a function of a capacity-dependent parameter of the charge transfer resistance between electrolyte and an electrode of the energy store.

17. The method as recited in claim 12, wherein the battery variable is calculated as a function of a deviation of the at least one capacity-dependent parameter from a reference value.

18. The method as recited in claim 17, wherein the deviation of the parameter is weighted with a specific factor.

19. The method as recited in claim 12, wherein the battery variable is also calculated as a function of a capacity-dependent parameter of an internal resistance.

20. The method as recited in claim 12, wherein the battery variable of the energy store is calculated as a function of a maximum open-circuit voltage, and the maximum open-circuit voltage is adapted using a learning algorithm.

21. The method as recited in claim 12, wherein the calculation is performed using a Kalman filter.

22. The method as recited in claim 12, wherein the battery variable is calculated as a function of a capacity-dependent parameter of a double-layer capacity between the electrolyte and an electrode of the energy store.

23. A device for determining a battery variable of an energy store, comprising:
a unit adapted to calculate from operating variables of the energy store state variables and parameters of a mathematical energy storage model, the battery variable being calculated as a function of a capacity-dependent parameter.

24. The device as recited in claim 23, wherein the battery variable is a capacity.
